(19) United States
(12) Patent Application Publication
(10) Pub. No.: US 2004/0160126 A1
(43) Pub. Date: Aug. 19, 2004

(54) Vehicle door operation system

(75) Inventors: Koji Aoki, Nagoya-shi (JP); Yuichi Murakami, Chiryu-shi (JP); Katsutoshi Fukunaga, Chiryu-shi (JP); Akio Sugiki, Kariya-shi (JP); Norikazu Kobayashi, Chita-shi (JP); Koichi Hirota, Takahama-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/722,401

(22) Filed: Nov. 28, 2003

(30) Foreign Application Priority Data
Nov. 28, 2002 (JP) 2002-346026

(51) Int. Cl. H01H 47/22

(52) U.S. Cl. 307/10.2

(57) ABSTRACT

A vehicle door operation system for operating a first door and a second door provided to a vehicle includes a sending means, a portable station carried by a user, a receiving means, a judging means, an object detecting means including an electrical capacitance sensor for detecting a human approach, an opening operation means provided to the second door, a first control means for switching the first door and the second door from a locked condition to an unlocked condition when the ID information is verified as correct information by the judging means, and either an object detecting signal from the object detecting means or an opening operation signal from the opening operation means is input thereinto, and a second control means for actuating a supporting means supporting the second door relative to the vehicle to release the second door when the ID information is verified as correct information by the judging means, and the opening operation signal from the opening operation means is input thereinto.

This application is based on and claims priority under 35 U.S.C. § 119 with respect to Japanese Application No. 2002-346026 filed on Nov. 28, 2002, the entire content of which is incorporated herein by reference.

### FIELD OF THE INVENTION

This invention generally relates to a vehicle door operation system. More particularly, the present invention pertains to a system for switching at least the vehicle door from a locked condition to an unlocked condition.

### BACKGROUND OF THE INVENTION

A known vehicle door operation system (hereinafter called system) is disclosed in Japanese Patent Laid-Open Publication No. 2002-30844.

The system includes a sending portion and a sending antenna provided at the vehicle door for sending a request signal, a portable station for sending ID data in response to the request signal, a receiving portion and a receiving antenna for receiving an ID information from the portable station, a sensor electrode and a sensor detecting portion provided at the vehicle door for detecting that a user put his hand close to the vehicle door, and a controller for switching the vehicle door from being locked to being unlocked, when the ID information has been verified, and the sensor electrode detects that the user put his hand close to the vehicle door.

A configuration has been considered according to the aforementioned system of the vehicle having plural doors thereat, for example, that all vehicle doors are switched from being locked to being unlocked based on the received signals from the sending antenna and the sensor electrode provided only at a driver's door. In this case, however, all vehicle doors except the driver's door can be opened only after the user put his hand close to the sensor electrode of the driver's door for unlocking the driver's door. In other words, when the all doors are locked, the doors except the driver's door cannot be opened by operation of an outside handle thereof. The sending portion, the sending antenna and the sensor electrode may be provided to each door to solve the problem, however, this configuration is considered as undesirable from the aspect of cost-effectiveness.

Thus, it is a purpose of the present invention to solve aforementioned problems by improving the operationality of switching operation of the vehicle door from being locked to being unlocked while keeping the cost down.

### SUMMARY OF THE INVENTION

According to an aspect of the present invention, a vehicle door operation system for operating a first door and a second door provided to a vehicle on one side of the vehicle in line, includes a sending means provided to either the first door or the second door for sending a request signal, a portable station carried by a user of the vehicle, including a receiving antenna, a sending antenna, a sending and receiving circuit, and a key control means for sending an ID information in response to the request signal, a receiving means provided to the vehicle for receiving the ID information sent from the portable station, a judging means provided to the vehicle for judging whether or not the ID information sent from the portable station is correct, an object detecting means including an electrical capacitance sensor for detecting a human approach provided to the first door for detecting an object, an opening operation means provided to the second door and operated for opening the second door.

According to another aspect of the present invention, a first control means provided to the vehicle and connected to the receiving means and the sending means for switching the first door and the second door from a locked condition to an unlocked condition when the ID information is verified as correct information by the judging means, and either an object detecting signal from the object detecting means or an opening operation signal from the opening operation means is input thereinto.

According to further aspect of the present invention, a second control means is provided to the second door of the vehicle and connected to the opening operation means for actuating a supporting means supporting the second door relative to the vehicle to release the second door when the ID information is verified as correct information by the judging means, and the opening operation signal from the opening operation means is input thereinto.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements and wherein:

FIG. 1 illustrates a configuration of the vehicle door operation system provided at the vehicle according to the present invention;

FIG. 2 illustrates a block diagram showing a configuration of the vehicle door operation system according to the current invention;

FIG. 3 illustrates a flowchart of a first control means of the vehicle door operating system according to the current invention; and

FIG. 4 illustrate a flowchart of a second control means of the vehicle door operation system according to the current invention.

### DETAILED DESCRIPTION OF THE INVENTION

A preferred embodiment of the present invention will be described hereinbelow in detail with reference to the accompanying drawings. A vehicle door operation system 10 (hereinafter called system 10) comprises a system (e.g. a smart entry system) for switching a vehicle door from being locked to being unlocked when it detects that a user is in the vicinity of the vehicle and puts his hand close to a door handle for opening the vehicle door. The system 10 according to the preferred embodiment of the current invention switches the two vehicle doors, a front door 2 (first door) and a rear door 3 (second door) from a locked condition to an unlocked condition. The front door 2 and the rear door 3 are provided on one side of the vehicle 1 in line.

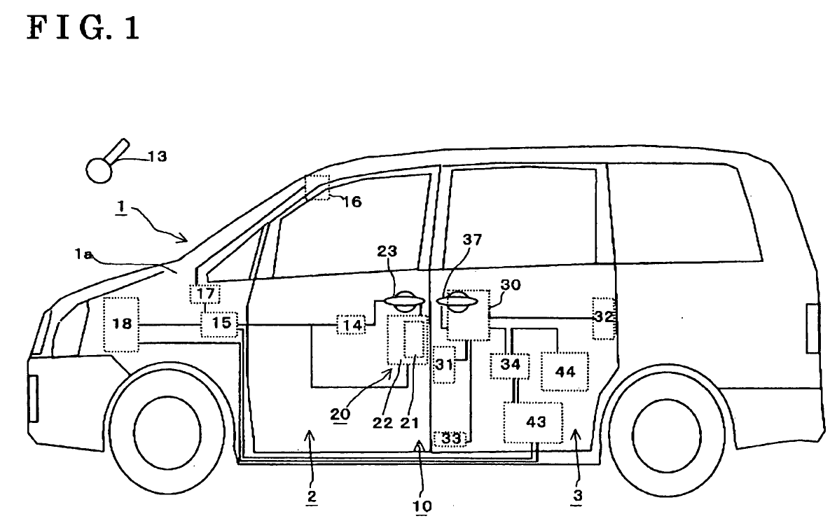

The door 2, which is a swing-type door including a hinge mechanism (not shown) at the front edge thereof (leftward in FIG. 1), opens outwardly in the vehicle wide direction. A door lock device 20 is provided near the rear end of the front door 2 in longitudinal direction of the vehicle (rightward in FIG. 1). The door lock device 20 includes a latch mechanism 21 meshing with a striker (not shown) which is fixed to a body 1a of the vehicle 1, and a door lock mechanism 22 having levers and a link and the like.

The latch mechanism 21 with a known structure keeps the front door 2 closed relative to the vehicle 1 by engaging with the striker. The lock mechanism 22 is roughly comprised of opening members and closing members. The opening members are connected to an outside handle 23 and an inside handle (not shown) of the front door 2 by a link or a cable and the like. An operation torque can be transmitted to the latch mechanism 21 when the outside handle 23 or the inside handle is operated. Specifically, the latch mechanism 21 engaged with the strikers for keeping the front door 2 closed becomes disengaged from the strikers in response to the operation of the outside handle 23 or the inside handle for opening the front door 2.

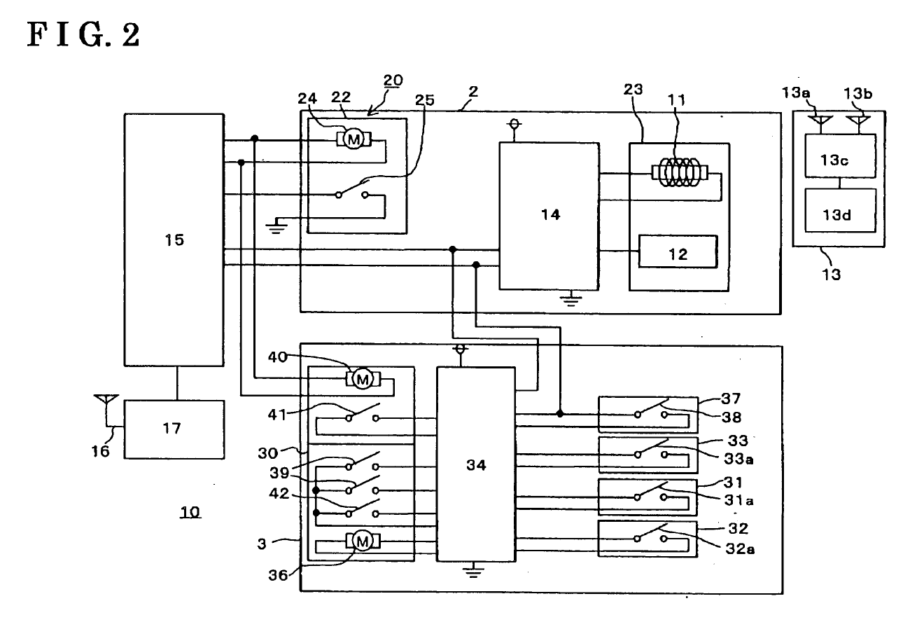

The locking members are connected to a lock knob (not shown) and the like provided to the inside surface of the front door 2 for engaging and disengaging a part of the aforementioned torque communication channel comprised of the opening member in response to the operation the lock knob. Thus the front door 2 is switched between being locked and being unlocked. A locking motor 24 (shown in FIG. 2) is provided as another locking member of the lock mechanism 22, and the front door 2 is switched between being locked and being unlocked by a drive of the locking motor 24. The locking motor 24 is connected to a lock electric control unit 15 (hereinafter called ECU 15) (detecting means, first control means) which is provided to the body 1a side of the vehicle and connected with a battery 18 for controlling the drive of the locking motor 24. An operation of the lock ECU 15 will be described later.

A front lock position switch 25 (shown in FIG. 2) is provided as the locking member of the lock mechanism 22 for detecting whether or not the front door 2 is locked by detecting the positions of the lever and the like of the lock mechanism 22. As shown in FIG. 2, the front lock position switch 25 is also connected to the lock ECU 15.

The slide type rear door 3 moves from the position as shown in FIG. 1 to the rear of the vehicle (rightward direction in FIG. 1) along a rail (not shown) provided at the vehicle 1. The rear door 3 includes a remote control mechanism 30, a front latch mechanism 31 (holding means), a rear latch mechanism 32 (holding means), a stopper mechanism 33 for stopping the rear door 2 in the fully opened position, and a latch electric control unit 34 (hereinafter called ECU 34) (second control means).

The front latch mechanism 31 and the rear latch mechanism 32 with known latch mechanism engage with the strikers (not shown) provided at the body 1a side of the vehicle for keeping the rear door 3 closed relative to the vehicle 1. The stopper mechanism 33, having the same known mechanism as the latch mechanism 21 has, keeps the rear door 3 fully opened relative to the vehicle 1 by meshing with the striker (not shown) provided at the body 1a side when the rear door 3 slides in the rear direction of the vehicle then reaches to the fully opened position. The front latch mechanism 31, rear latch mechanism 32 and the stopper mechanism 33 are connected to the remote controller 30 by cables and the like.

A front latch switch 31a, a rear latch switch 32a and a stopper switch 33a are provided at the front latch mechanism 31 (shown in FIG. 2) and the like. These switches 31a, 32a and 33a recognize whether or not the front latch mechanism 31 is engaged with the striker and are connected to the latch ECU 34 as shown in FIG. 2.

The remote control 30 including a lever, a link and the like is also roughly comprised of opening members and locking members. The opening member are connected to an inside handle (not shown) provided at the inside surface of the rear door 3 by a link and a cable (not shown) for mechanically transmitting an operation torque to the front latch mechanism 31 and the like in response to the operation of the inside handle. Specifically, when the rear door 3 is closed, the front latch mechanism 31 and the rear latch mechanism 32 are switched from being engaged with the strikers respectively for keeping the rear door 3 closed to being disengaged from the strikers for opening the rear door 3 in response to the operation of the inside handle. On the other hand, when the rear door 3 is fully opened, the stopper mechanism 33 is switched from being engaged with the striker for keeping the rear door 3 opened to being disengaged from the strikers for closing the rear door 3 in response to the operation of the inside handle.

A latch release motor 36 (shown in FIG. 2) is provided as the opening member of the remote control 30. The front latch mechanism 31 and the like can be actuated by a drive of the latch release motor 36. As shown in FIG. 2, the latch release motor 36 is connected to the latch ECU 34 and controlled by the drive of the latch ECU 34. The latch ECU 34 is connected to an outside open switch 38 (opening operation means) (shown in FIG. 2) provided at an outside handle 37 of the rear door 3. When the outside open switch 38 is operated, a signal is send for driving the latch release motor 36. In other word, when the outside open switch 38 is operated during the door has been unlocked, the latch ECU 34 drives the latch release motor 36 directly.

The latch ECU 34 is connected to an inside open switch 39 provided at the remote control 30. The inside open switch 39 is turned on or off in response to the operation of the inside handle of the rear door 3. The latch ECU 34 drives the latch release motor 36 by the operation of the inside open switch 39 during the rear door 3 has been unlocked. An operation stroke of the inside handle of the rear door 3 until the inside open switch 39 is turned on is set to be smaller than an operation stroke for the aforementioned mechanical actuation of the front latch mechanism 31. The rear door 3 is opened from the inside of the vehicle normally by driving of the latch release motor 36 based on an “ON” signal from the inside open switch 39. The aforementioned mechanical actuation of the front latch mechanism 31 and the like in response to the operation of the inside handle rather undertakes a role as a fail-safe device in case of the latch ECU 34 is broken.

The locking members of the remote control 30 are connected to the lock knob (not shown) provided to the inside surface of the rear door 3 for engaging or disengaging a part of the torque communication channel from the aforementioned inside handle to the front latch mechanism 31. As a result, the rear door 3 is switched between being locked and being unlocked. In addition, a locking motor 40 is provided as a locking member for switching the rear door 3 between being locked and being unlocked. As shown in FIG. 2, the locking motor 40 is connected to and controlled by the ECU 15 provided at the body 1a side.

As another locking member of the remote controller 30, a rear lock position switch 41 (shown in FIG. 2) is provided for detecting whether or not the rear door 3 is locked by detecting positions of the lever and the like. The latch ECU 34 is connected to the lock position switch 41 for controlling the rear door 3 to be locked in response to a signal sent from the lock position switch 41 when the switch is turned on thereat (the rear door is locked) due to the actuation of the locking member by a drive of the locking motor 40 and the like. In this condition, the latch ECU 34 controls the latch release motor 36 not to drive even if an “ON” signals are sent from the outside open switch 38 and the inside open switch 39 by the operations thereof. Thus, when the latch ECU 34 controls the rear door 3 to be locked, the signals from the outside opens switch 38 side and the like are rejected unlike under the unlocked state.

A child protect switch 42 is provided to the remote controller 30 (shown FIG. 2) and connected to the latch ECU 34 as shown in FIG. 2. The child protect switch 42 can be turned on according to an operation of a child protector lever (not shown) provided to the inside surface the rear door 3. When an “ON” signal is input from the child protect switch 42, the latch ECU 34 controls a release motor 35 not to follow the “ON” signal from the inside open switch 39.

As shown in FIG. 1, the latch ECU 34 is connected to a battery 18 on the body 1a side via a power supply device 43. In addition, an electric-driven slide door device 44 and an electric-driven closer device (not shown) are provided the rear door 3, however, a details of these devices will not be described.

Devices which comprises the system 10, especially the aforementioned smart entry system, will be explained as follows. An antenna 11 (sending means) (shown in FIG. 2) and a sensor electrode 12 (object detection means) (shown in FIG. 2) are provided to the outside handle 23. The antenna 11 is comprised of a ferrite core with a coil wound thereon and sends a request signal of a predetermined frequency to the outside of the vehicle 1, and the request signal can be transmitted to a key 13 (portable station) which is carried by the user. The sensor electrode 12 is comprised of a nonmagnetic member of high-conductivity and detects that the user (especially their hand) is approaching to the outside handle 23 based on a change of an electrical capacitance.

The antenna 11 and the sensor electrode 12 are connected to a transmission circuit 14 (sending means, object detection means). A position of the transmission circuit 14 is not limited to a particular place; however, the transmission circuit 14 is usually provided near a panel provided inside surface of the front door 2. The transmission circuit 14 has two combined functions, a function as an amplification circuit of a request signal from the antenna 11, and a function as a sending circuit of the electrical capacitance sensor cooperating with the sensor electrode 12. The signal from the lock ECU 15 can switch these functions of the transmission circuit 14 as described later.

The aforementioned key 13 includes a receiving antenna 13a, a sending antenna 13b, a sending and receiving circuit 13c and a key electric control unit 13d (hereinafter called key ECU 13d) (key control means) (shown in FIG. 2) and the like. Once the key 13 receives a request signal from the vehicle 1 side through the receiving antenna 13a, the key 13 sends an answer signal and the like including the ID information (e.g. ID code) through the sending antenna 13b in response to the request signal.

A receiving antenna 16 (receiving means) is provided to the vehicle 1. The receiving antenna 16 may be provided at a room mirror, near an instrument panel or at a pillar. The receiving antenna 16 is connected to a receiving circuit 17 (receiving means) which is connected to the lock ECU 15. The answer signal from the key 13 is demodulated at the receiving circuit 17 and transmitted to the lock ECU.

As shown in FIG. 2, the lock ECU 15 is also connected to the latch ECU 34 of the rear door 3 and the outside open switch 38. Thus, the lock ECU 15 and the latch ECU 34 cooperatively execute control programs as follows.

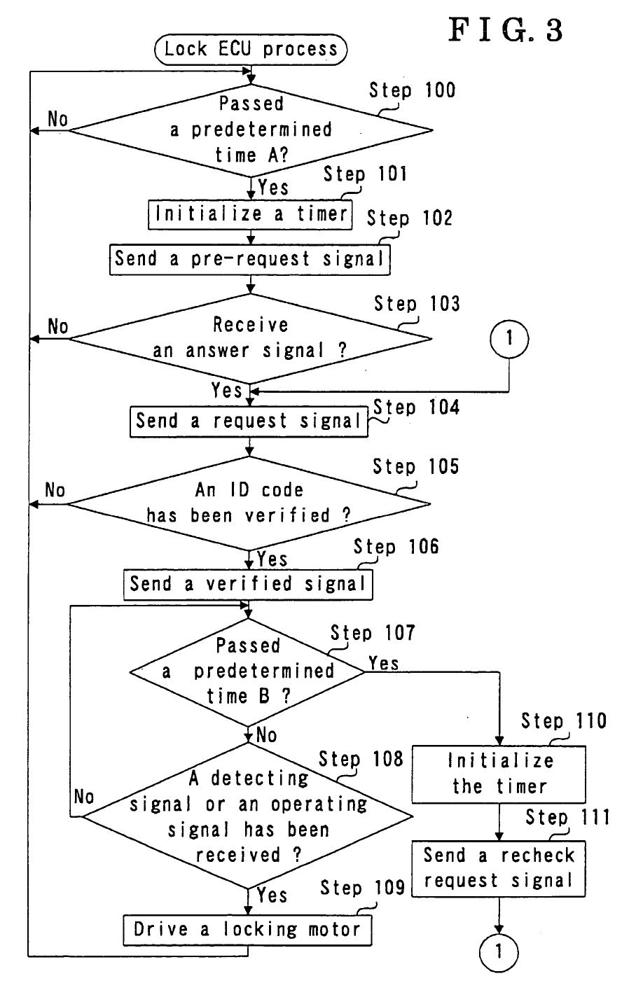

A process of the lock ECU 15 will be described according to FIG. 3. The process is repeated at a predetermined interval not depending on whether or not the ignition of the vehicle 1 is turned on. In Step 100, the lock ECU 15 judges whether or not a time of a timer of the lock ECU 15 exceeds a predetermined time A (e.g. 0.3 s). If the time of the timer has not passed the predetermined time A, the process goes to Step 100. On the other hand, if the time of the timer has passed the predetermined time A, the process goes to Step 101.

In Step 101, the timer is initialized, then the process goes to Step 102. In Step 102, the lock ECU 15 sends a request signal of a predetermined frequency, so called a pre-request signal, to the outside of the vehicle 1 via the sending circuit 14 and the antenna 11.

In Step 103, the lock ECU 15 judges whether or not an answer signal from the key 13 received the pre-request signal has been received through the receiving antenna 16 and the receiving circuit 17. If the lock ECU 15 has not received the answer signal, the process goes to Step 100. If the lock ECU 15 has received the answer signal, it is confirmed that a people who possesses the key 13 has been in the vicinity of the vehicle 1 (within an output area in which the answer signal is radially transmitted to the outside of the vehicle from the antenna 11 with a predetermined radius), then the process goes to Step 104.

In Step 104, the lock ECU 15 sends a request signal of a predetermined frequency, so called ID request signal, to the outside of the vehicle 1 via the sending circuit 14 and the antenna 11, and the process goes to Step 105. In this case, the key 13 sends the answer signal including the ID information (including an ID code and the like) from the sending antenna 13b as aforementioned above in response to the request signal.

In Step 105, the lock ECU 15 judges whether or not the ID information sent from the key 13 and received via the receiving antenna 16 and the receiving circuit 17 is correct information. In other word, the lock ECU 15 judges whether or not the ID information corresponds to an ID information which is saved in a memory of the lock ECU 15. If the ID information has not been confirmed as correct information, the process goes to Step 100. If the ID information has been confirmed as correct information, the people who has been in the vicinity of the vehicle 1 with the key 13 has been verified as a user of the vehicle 1.

In Step 106, the lock ECU 15 sends a verified signal to the sending circuit 14 and the latch ECU 34. The receiving circuit 14 switches its function and becomes the sending circuit for sending the electrical capacitance sensor, which cooperates with the sensor electrode. An operation of the latch ECU 34 will be described later. The process goes to Step 107.

In Step 107, the lock ECU 15 judges whether or not a time of the timer in the lock ECU 15 has passed a predetermined time B (e.g. 3 s). If the time of the timer has not passes the predetermined time B, the process goes to Step 108. If the time of the timer has passes the predetermined time B, the process goes to Step 110. In Step 108; the lock ECU 16 judges whether or not a detecting signal (object detecting signal) for detecting that the user put his hand close to the outside open switch 38 has been input from the sensor electrode 12 and the sending circuit 14, or whether or not an operating signal (opening operation signal) has been input from the outside open switch 38. If one or the other of these signals is input, the process goes to Step 109. If none of them is input, the process goes to Step 107.

In Step 109, the lock ECU 15 sends a driving signal to the locking motor 24, 40, as a result, the front door 2 and the rear door 3 are switched from being locked to being unlocked. Then, the process goes to Step 100.

In Step 110, on the other hand, the timer is initialized, then the process goes to Step 111. In Step 111, the lock ECU 15 sends a recheck request signal to the sending circuit 14, then the process goes to Step 104. In response to the recheck request signal, the sending circuit 14 switches its function and becomes the amplification circuit of the request signal from the antenna 11. In other word, if the lock ECU 15 verifies that the user of the vehicle 1 has been near the vehicle 1, and the detecting signal and the like are not input within the predetermined time B, the sending circuit 14 becomes the amplification circuit of the request signal from the antenna 11 for confirming whether or not the user of the vehicle 1 is still in the vicinity of the vehicle.

As described above, if the lock ECU 15 judges the ID information is correct, the front door 2 and the rear door 3 are switched from being locked to being unlocked in response to either the detection signal input from the front door 2 side or the operating signal input from the rear door 3 side. Thus, both the front door 2 and the rear door 3 can be unlocked directly by the operation of either the front door 2 or the rear door 3. There is no need to put a hand close to the sensor electrode of the front door 2 for unlocking the rear door 3. In this way, the unlocking operation becomes more user-friendly. In addition, the cost of the system 10 can be kept down because there is no need to provide, for example, an additional electrode like the sensor electrode 12 to the rear door 3 having the outside open switch 38 for originally opening the rear door 3.

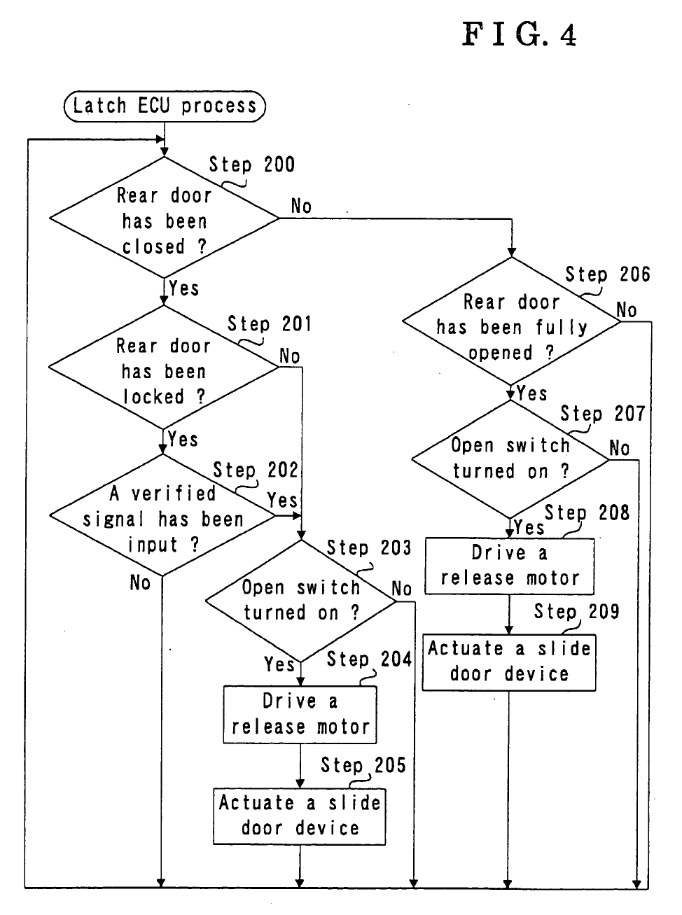

The process of the operation of the latch ECU 34 will be described hereinafter according to the FIG. 4. The process is repeated at a predetermined interval not depending on whether or not the ignition of the vehicle 1 is turned on. In Step 200, the latch ECU 34 judges whether or not the rear door 3 has been opened based on the signals from the front latch switch 31a and the rear latch switch 32a. In other word, the latch ECU 34 judges whether or not the front latch mechanism 31 and the rear latch mechanism 32 engage with the strikers (whether or not the rear door 3 is closed). If the rear door 3 has been closed, the process goes to Step 201. If the rear door has not been closed, the process goes to Step 206.

In Step 201, the latch ECU 34 judges whether or not the rear door 3 has been locked based on the signal from the lock position switch 41. If the rear door 3 has been locked, the process goes to Step 202. If the rear door 3 has been unlocked, the process goes to Step 203. In Step 202, the latch ECU 34 judges whether or not the latch ECU 34 receives the verified signal from the lock ECU 15. If the verified signal has not been received, the process goes to Step 200. If the verified signal has been received, the process goes to Step 203.

In Step 203, the latch ECU 34 judges whether or not the latch ECU 34 receives the operation signal from the outside open switch 38. If the ECU 34 has not received the operation signal, the process goes to Step 200. If the ECU 34 has received the operation signal, the process goes to Step 204. In Step 204, the latch ECU 34 sends the driving signal to the latch release motor 36. The front latch mechanism 31 is rotated to disengage from the striker on the body 1a side, then the rear door 3 is enabled to be opened. The process goes to Step 205. In Step 205, the latch EUC 34 actuates the slide door device for opening the rear door 3. The process goes to Step 200.

As described above, the latch ECU 34 receives the verified signal which is sent from the lock RCU 15 in Step 105 for verifying that the ID information is correct, then the process goes from Step 202 to Step 203. When the latch ECU 34 judges that the ID information is correct according to the received verified signal, the front latch mechanism 31 and the rear latch mechanism 32 are actuated, in other word, the rear door 3 is enabled to be opened based on the operation signal from the outside open switch 38 even if the rear door 3 has been locked. Thus, the latch ECU 34 controls the rear door 3 to be opened in parallel that the lock EUC 16 unlocks the front door 2 and the rear door 3 (in Step 109). The rear door 3 is opened smoothly without any time lag for opening operation because there is no need to wait for the rear door 3 to be unlocked before it is opened.

In Step 206, on the other hand, the latch ECU 34 judges whether or not the rear door 3 is full opened based on a signal from the fully stopper switch 33a. In other word, the latch ECU 34 judges whether or not the stopper mechanism 33 meshes with the striker (whether or not the rear door 3 is fully opened). If the rear door 3 is fully opened, the process goes to the Step 207. If the rear door 3 is not fully opened, the process goes to Step 200.

In Step 207, the latch ECU 34 judges whether or not the latch ECU 34 has been received the operating signal from the outside open switch 38. If the latch ECU 34 has not received the operating signal, the process goes to Step 200. If the latch ECU 34 has received the operating signal, the process goes to Step 208. In Step 208, the latch ECU 34 sends the operating signal to the latch release motor 36. As a result, the stopper mechanism 33 is actuated (the front latch mechanism 31 and the rear latch mechanism 32 are also actuated) for disengaging from the striker of the body 1a, then the rear door 3 is enabled to be opened. In Step 209, the rear door 3 is closed by the actuation of the slide door device, then the process goes to Step 200.

The present invention is not limited only to the above preferred embodiment. In the embodiment of the present invention, the front door 2 and the rear door 3 are juxtaposed at the one side of the vehicle, however, the doors may not be juxtaposed. For example, the plural doors may be provided at both sides of the vehicle 1. When the plural doors are provided at both sides of the vehicle 1, however, the doors on the other side of the vehicle 1 may not be operated by the system 10 because the embodiment of the present invention refers to the plural doors (the front door 2 and the rear door 3) juxtaposed in line at the one side of the vehicle 1. This configuration can prevent the vehicle from being broke into through one of the doors on the other side. In addition, the system 10 works as long as the output area of the request signal from the antenna 11 covers the output area on one side of the vehicle. This configuration can save the power for outputting the request signal. The plural doors provided at the rear of the one side of the vehicle 1 may be gate fold-style.

In the embodiment of the present invention, the latch ECU 34 is provided at the rear door 3, however, the latch ECU 34 may be provided alternatively at the body 1a side of the vehicle 1. In addition, the latch ECU 34 may be provided integrally with the lock ECU 15.

In the embodiment of the present invention, the antenna 11 and the sensor electrode 12 are provided inside of the outside handle 23, however, the antenna 11 and the sensor electrode 12 may be provided, for example, inside of the front door 2 alternatively. Furthermore, the antenna 11 and the sending circuit 14 are provided at the front door 2 side in the embodiment of the present invention, however, the antenna 11 and the sending circuit 14 can be provided at the rear door 3 side, or both the rear door 3 and the front door 2. Another configuration, such as the sensor electrode 12 is provided at the rear door 3 side and the outside open switch 38 is provided at the front door 2 side, can be applied to the system 10 alternatively.

In the embodiment of the present invention, the electrical capacitance-type sensor is used for detecting a human body; however, an optical sensor can be applied instead of the electrical capacitance-type sensor to the system 10.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door operation system for operating a first door and a second door provided to a vehicle, comprising:
a sending means provided to either the first door or the second door for sending a request signal;
a portable station for sending an ID information in response to the request signal;
a receiving means provided to the vehicle for receiving the ID information sent from the portable station;
a judging means provided to the vehicle for judging whether or not the ID information sent from the portable station is correct;
an object detecting means provided to the first door for detecting an object;
an opening operation means provided to the second door and operated for opening the second door; and
a first control means for switching the first door and the second door from a locked condition to an unlocked condition when the ID information is verified as correct information by the judging means, and either an object detecting signal from the object detecting means or an opening operation signal from the opening operation means is input thereinto.

2. A vehicle door operation system according to claim 1, wherein a second control means is provided to the vehicle for actuating a supporting means supporting the second door relative to the vehicle to release the second door when the ID information is verified as correct information by the judging means, and the opening operation signal from the opening operation means is input thereinto.

3. A vehicle door operation system according to claim 1, wherein the first door and the second door are provided in line.

4. A vehicle door operation system according to claim 2, wherein the first door and the second door are provided in line.

5. A vehicle door operation system according to claim 1, wherein the object detecting means is comprised of an electrical capacitance sensor for detecting a human approach.

6. A vehicle door operation system according to claim 2, wherein the object detecting means is comprised of the electrical capacitance sensor for detecting a human approach.

7. A vehicle door operation system according to claim 3, wherein the object detecting means is comprised of the electrical capacitance sensor for detecting a human approach.

8. A vehicle door operation system according to claim 1, wherein the portable station carried by a user of the vehicle includes a receiving antenna, a sending antenna, a sending and receiving circuit and a key control means.

9. A vehicle door operation system according to claim 1, wherein the first control means provided to the vehicle is connected to the receiving means and the sending means.

10. A vehicle door operation system according to claim 2, wherein the second control means provided to the second door is connected to the opening operation means.

11. A vehicle door operation system according to claim 3, wherein the first door and the second door are provided on one side of the vehicle.

12. A vehicle door operation system according to claim 4, wherein the first door and the second door are provided on one side of the vehicle.
